(19) United States
(12) Patent Application Publication
(10) Pub. No.: US 2007/0223725 A1
(43) Pub. Date: Sep. 27, 2007

(54) Method and apparatus for wirelessly streaming multi-channel content

(76) Inventors: John C. Neumann, Chicago, IL (US); Simone Koo, Palatine, IL (US); Arnold Sheynman, Northbrook, IL (US)

Correspondence Address: PHILIP H. BURRUS, IV, 460 Grant Street, Atlanta, GA, 30312, US

(21) Appl. No.: 11/388,424

(22) Filed: Mar. 24, 2006

(51) Int. Cl. H04B 3/00

(52) U.S. Cl. 381/80; 381/313

(57) ABSTRACT

A method and apparatus are provided for wirelessly delivering multi-channel content (106) from an electronic device (201), such as a MP3 player or mobile telephone having multi-media capabilities, to a user. A system (200) includes the electronic device (201), a first wireless loudspeaker device (100) and a second wireless loudspeaker device (205). One of the wireless loudspeaker devices (100) establishes a point-to-multipoint communication structure with the electronic device (201) and the other, matching wireless loudspeaker device (205). As such, the electronic device (201) is able to deliver multi-channel content (106) to the first wireless loudspeaker device (100) with a single transceiver (252). The wireless loudspeaker device (100) may then deliver single-channel content to a locally disposed loudspeaker (103). The wireless loudspeaker device (100) also transmits single-channel content (107) to the second wireless loudspeaker device (205). The wireless loudspeaker devices (100,205) are capable of negotiating an ascendancy relationship between themselves, with one wireless loudspeaker device becoming dominant. This relationship may be transferred without interrupting content delivery to the user.

### BACKGROUND

1. Technical Field

This invention relates generally wirelessly providing multi-channel content to a portable loudspeaker device, and more specifically to a method and apparatus for wirelessly streaming multi-channel content from an electronic device to a plurality of wireless loudspeaker devices.

2. Background Art

Portable music players are becoming ever more popular. Due to the advent of digital recording and advanced data compression techniques, radios and portable cassette tape players have given way to digital devices that store thousands of songs, for example, on a miniature hard disc or in flash memory. Words like “podcast” and “MP3”, once known only to the technically astute, are now a part of the everyday lexicon.

While people—both young and old—now use digital players for audio and video content, one limitation associated with these players involves the delivery of audio to the user, specifically, the connection between the player and the ear. As people often listen to audio content in crowded settings, from gyms to trains to parks, they generally employ headphones or earpieces to listen privately without disturbing others. The problem with such headphones is that they must be wire-coupled to the player. As such, the user must wear the player on the arm or belt so that a wire may connect the earphones to the player. As anyone who has ever walked too close to a doorknob knows, these wires are susceptible to becoming entangled about protruding objects, potentially causing damage to the headphones, the player, or both.

One prior art solution to this “wired earpiece” problem is wireless headphones. In a pair of wireless headphones, a user purchases a special transmitter that is coupled to a content player. The special transmitter then transfers data to the headphones, which has earphones that are wired together about the user's head. The problem with such a prior art solution is three-fold: First, the headphones are wired together about the user's head. As such, the headphone assembly is bulky and conspicuous. Further, such a headphone assembly often has a negative impact on a person's hairstyle, as it generally leaves a mark or indentation where the headphone assembly spanned the head.

Second, for stereo data transmission to the headphone assembly, multiple transmitters are required. To transmit both right and left channels, a first transmitter is required to transmit the left channel, while a second transmitter is required to transmit the right channel. Additionally, sophisticated software is required to multiplex the data from the media source to the multiple transmitters.

Third, some players are capable of transmitting both single-channel and multi-channel content. For example, the ROKR™ mobile telephone manufactured by Motorola, Inc. is capable of both playing stereo music in a digital format and making telephone calls. The telephone calls, due to the structure of the telephony network, are monaural, while the digital music is stereo. With a “stereo only” headphone assembly, the user is confronted with either a large initial investment to listen to monaural telephone calls, or, when buying a monaural headset, no expansion option to listen to stereo content.

There is thus a need for an improved method and apparatus for streaming multi-channel content wirelessly to multiple loudspeaker devices that does not require multiple transmitters in the content player and facilitates both monaural and stereo streaming.

### BRIEF DESCRIPTION OF THE DRAWINGS

FIG. 1 illustrates one embodiment of a wireless loudspeaker device in accordance with the invention.

FIG. 2 illustrates one embodiment of a system for streaming single-channel or multi-channel content from an electronic device to one or two wireless loudspeaker devices in accordance with the invention.

FIG. 3 illustrates a method for a device to configure multiple wireless loudspeaker devices for multi-channel streaming in accordance with one embodiment of the invention.

FIG. 4 illustrates a method for a wireless loudspeaker device to configure itself for communication with both a remote device and another wireless loudspeaker device in accordance with one embodiment of the invention.

FIG. 5 illustrates a method for a wireless loudspeaker device to configure itself for communication with another wireless loudspeaker device in accordance with one embodiment of the invention.

FIG. 6 illustrates a boot method for a wireless loudspeaker device in accordance with one embodiment of the invention.

FIG. 7 illustrates a wireless loudspeaker device with geometric orientation capabilities in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to stream multi-channel content from an electronic device to a one or more wireless loudspeaker devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of configuring and streaming single-channel or multi-channel content from an electronic device, such as a MP3 player or mobile telephone, to one or more wireless loudspeaker devices. The non-processor circuits may include, but are not limited to, a radio receiver, a radio transmitter, signal drivers, clock circuits, power source circuits, and user input devices. As such, these functions may be interpreted as steps of a method to perform wireless streaming of single-channel or multi-channel content to loudspeaker devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Described herein is a method and apparatus for wirelessly streaming single-channel or multi-channel content from an electronic device to one or more wireless loudspeaker devices. A method for initially configuring the wireless loudspeaker devices is also provided. In one embodiment, two identical wireless loudspeaker devices may be employed in tandem to form a single, multi-channel user interface system. As such, a user may purchase one wireless loudspeaker device initially for listening to monaural content. For example, the user may one only one wireless loudspeaker device for making hands-free telephone calls. The user may then purchase a second, identical wireless loudspeaker device at a later time, combining it with the first, to listen to stereo content. For example, they may want to listen to musical content in stereo. The wireless loudspeaker devices operate in a fashion that enables stereo pairing and streaming with an electronic device having only one transmitter or source.

In one embodiment of the invention, the wireless loudspeaker devices are compatible with Bluetooth local area network technology. As such, portable electronic devices equipped with Bluetooth transceiver circuitry, like mobile telephones, personal computers, and MP3 players for instance, may stream multi-channel content to the user with a single Bluetooth transceiver. While the A2DP Bluetooth profile for stereo streaming is only configured for streaming to a single device, software modules within the wireless loudspeaker devices enable multi-channel content delivery without modifications to the electronic device or player. While Bluetooth technology is one suitable wireless communication protocol for use with wireless loudspeaker devices in accordance with the invention, it will be clear to those of ordinary skill in the art having the benefit of this disclosure that the invention is not so limited. Other digital and analog wireless communication protocols may also be employed.

In one embodiment of the invention, the wireless loudspeaker devices are small, independent earpieces suitable for insertion into a user's ear canal by way of soft pliable flanges. Using this construction, the user is able to insert a wireless loudspeaker device into each ear for an undetectable listening experience. As the wireless loudspeaker devices are not physically coupled to each other, there is no wire or harness spanning the user's head. When using two wireless loudspeaker devices in conjunction with a wireless device like the Motorola ROKR™, the user may employ a single wireless loudspeaker device for making monaural phone calls, and both wireless loudspeaker devices for listening to stereo content.

Each wireless loudspeaker device is capable of maintaining a symmetrical point-to-multipoint connection to both the electronic device and the other wireless loudspeaker device. However, in one embodiment, only one wireless loudspeaker device does so. In this embodiment one wireless loudspeaker device takes on a dominant role, maintaining a point-to-multipoint connection, while the other wireless loudspeaker device takes on a subdominant role, maintaining only a point-to-point connection with the other wireless loudspeaker device. This dominant-subdominant relationship may be transferred and changed based upon any of a number of criteria, as will be described in further detail below.

In one embodiment of the invention, each wireless loudspeaker device is equipped with identical functional modules. These modules, which may be configured as embedded software operable with a processor disposed within the wireless loudspeaker device, enable the particular wireless loudspeaker device to serve as the dominant wireless loudspeaker device or the subdominant wireless loudspeaker device. Since the wireless loudspeaker device shipping from the factory may become either dominant or subdominant, in one embodiment each wireless loudspeaker device is capable of pairing with an electronic device. Where the electronic device comprises a mobile telephone, each wireless loudspeaker device is capable of facilitating a hands-free telephone call. Each wireless loudspeaker device is capable of negotiating a dominant-subdominant relationship with another wireless loudspeaker device. Each wireless loudspeaker device is capable of establishing a point-to-multipoint connection so as to be capable of serving as the dominant wireless loudspeaker device. Each wireless loudspeaker device is capable of receiving multi-channel content and distributing one channel to a local loudspeaker, while distributing another channel to a remote wireless loudspeaker device. Each of these functions will be described in more detail with the discussion of the figures below.

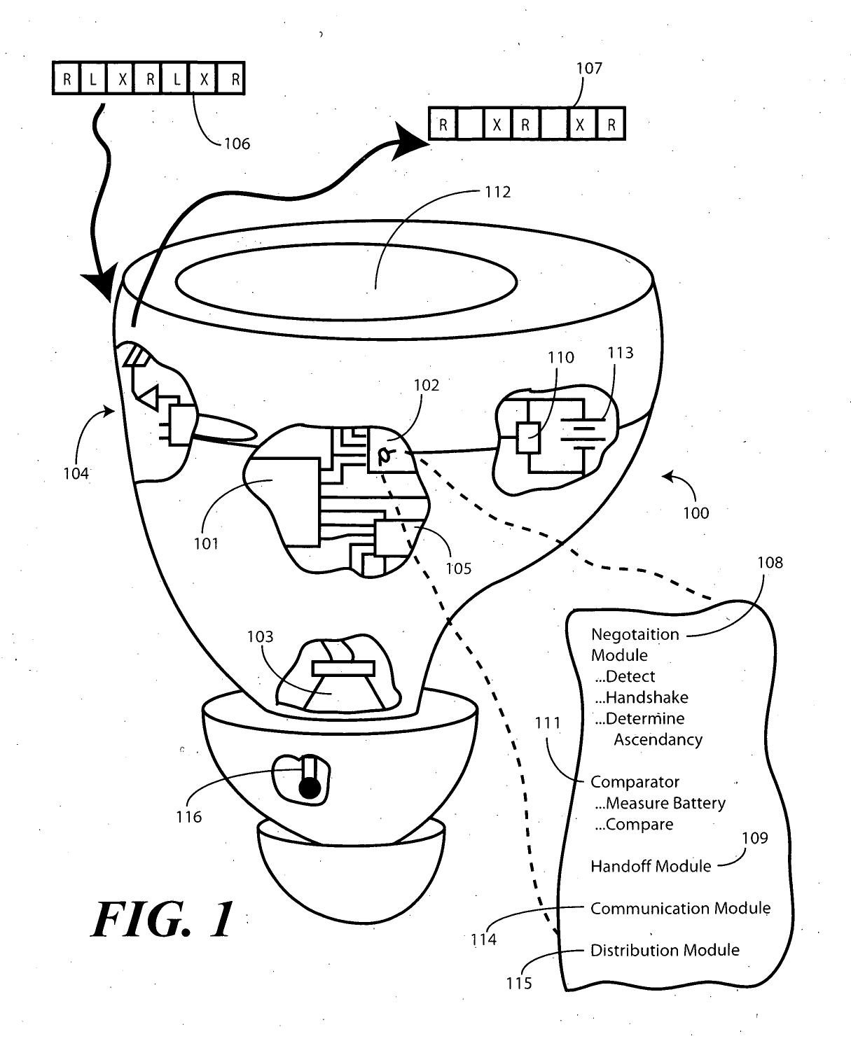

Turning now to FIG. 1, illustrated therein is one embodiment of a wireless loudspeaker device 100 in accordance with the invention. The wireless loudspeaker device 100 may include one or more buttons 112 that allow a user to control the operation of the wireless loudspeaker device 100. The wireless loudspeaker device 100 includes a processing circuit 101 and associated memory 102 for executing the various applications and functions necessary to operate the wireless loudspeaker device 100. The processing circuit 101, which may comprise a microprocessor with embedded software stored within the associated memory 102, controls the electrical components of the wireless loudspeaker device 100. The modules discussed herein, which may be configured as segments of software code executable in conjunction with the processing circuit 101, may also be stored in the associated memory 102.

A wireless transceiver 104 is coupled to the processing circuit 101. The processing circuit 101 directs the operation of the wireless transceiver 104 so as to make the device wirelessly communicable with other devices having similar wireless transceiver circuitry. As mentioned above, in one embodiment, the wireless transceiver 104 may be a Bluetooth compatible local area network communication circuit. The wireless transceiver 104, be it Bluetooth compatible or other, generally will include a radio-frequency antenna, amplification circuitry, and driver circuitry.

A loudspeaker 103 is operatively coupled to the processing circuit 101. When aural information is received by the wireless transceiver 104 and delivered to the processing circuit 101, the processing circuit 101 may deliver it to the loudspeaker 103 so as to make it audible to a user. Where the wireless loudspeaker device 100 is an earpiece designed to fit within the user's ear canal, the loudspeaker 103 may be greatly reduced in size. The wireless loudspeaker device 100 may optionally include a microphone 116 so as to be used for hands-free calls, for instance. The microphone 116 may be disposed internally, so as to pick up the user's voice through the ear canal. Alternatively, it may be placed along the exterior of the wireless loudspeaker device 100 so as to pick up sound through the air. Further, multiple microphones may be used.

A communication module 114, which may be configured as executable software code, is operable with the processing circuit 101 and is configured to establish a wireless communication channel with either a remote electronic device or another wireless loudspeaker device. Alternatively, the communication module 114 may make a point-to-multipoint communication connection with both a remote electronic device and another wireless loudspeaker device. As Bluetooth transceivers and associated circuitry are configured to communicate with LIP to seven devices, where Bluetooth is used as the wireless communication protocol, such a point-to-multipoint connection is easily accomplished.

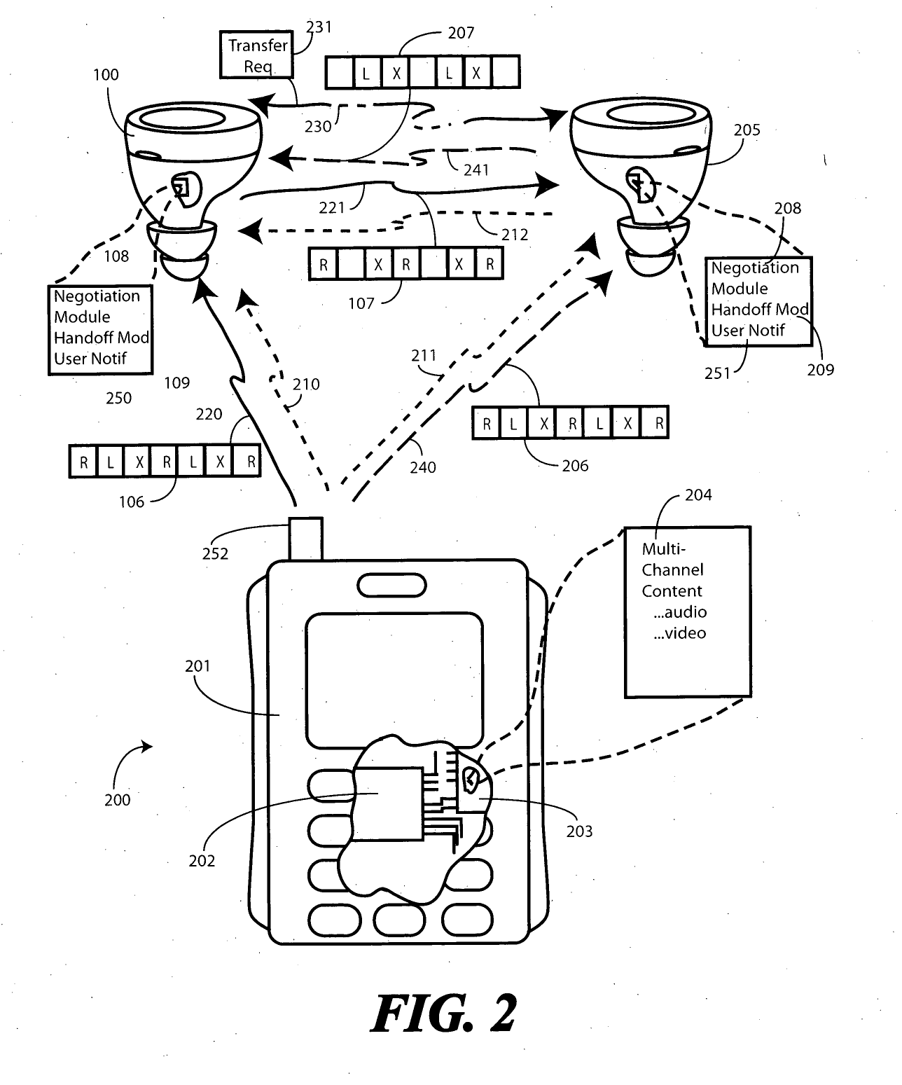

A distribution module 115 is operable with the processing circuit 101 and is configured to receive multi-channel content 106 from a remote electronic device. Where two wireless loudspeaker devices are in use, the distribution module 115 is configured to receive multi-channel content 106, and to distribute one channel locally, while transmitting another channel 107 to the other wireless loudspeaker device through the wireless transceiver 104. For example, where an electronic device like a MP3 player transmits multi-channel, stereo content 106, the distribution module 115 may select one channel from the multi-channel content 106 for delivery to the local loudspeaker 103. The distribution module 115 may then cause the other channel, i.e. single-channel content 107, to be transmitted to a remote wireless loudspeaker device through the wireless transceiver 104. Note that for many wireless transfer protocols, information other than channel content may be transmitted. Data content may be interlaced with other content, such as audio or video. For example, the content may include left channel audio, right channel audio, and data like call initiation, transfer, or drop requests. For such an embodiment, as illustrated in FIG. 1, the “R” of elements 106,107 may stand for “right channel content”, while the “L” stands for “left channel content”, and the “X” represents interlaced data. The distribution of content will be illustrated in more detail in the discussion of FIG. 2.

As mentioned above, in one embodiment of the invention, two identical wireless loudspeaker devices are employed to deliver multi-channel content to the user. As such, each wireless loudspeaker device is symmetrical in geometric shape, and may be placed in either the right or left ear. So that the wireless loudspeaker device 100 may determine which ear it is in, and thus which channel of the multi-channel content to deliver locally to the loudspeaker 103 and which to deliver to the other wireless loudspeaker device, an orientation module 105 may be coupled to the processing circuit 101. The orientation module 105 is capable of determining a physical orientation of the wireless loudspeaker device 100. Once the orientation module 105 determines the physical orientation of the wireless loudspeaker device 100, the orientation module 105 may direct the distribution module 115 to transmit the proper channel to the other wireless loudspeaker device. For example, if the wireless loudspeaker device 100 determines the wireless loudspeaker device 100 is in the left ear, the distribution module 115 will select the left channel from the multi-channel content 106 for delivery to the loudspeaker 103, while delivering the right channel 107 to the other wireless loudspeaker device. The opposite is also true.

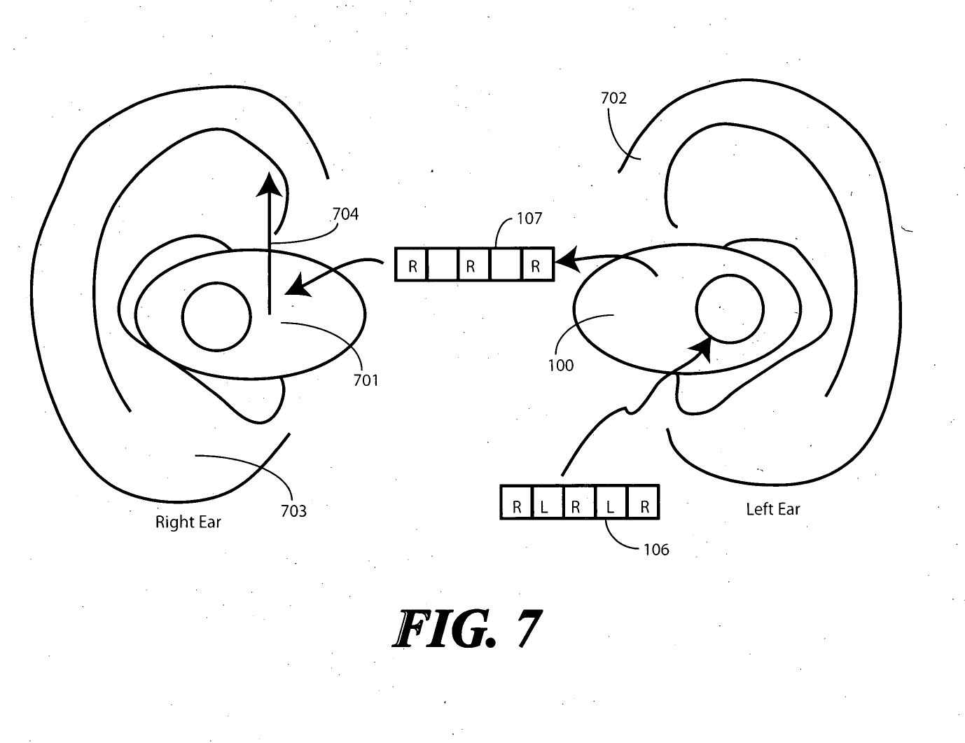

One example of a suitable orientation module 105 is an accelerometer. Accelerometers, which are manufactured as solid-state semiconductor devices, are capable of determining for example in which direction gravity is acting. Turning briefly to FIG. 7, illustrated therein is one application for orientation modules 105 in accordance with the invention. In FIG. 7, a first wireless loudspeaker device 100 has been inserted into the left ear 702, while a second wireless loudspeaker device 701 has been inserted in the right ear 703. The orientation module (105) in the first wireless loudspeaker device 100 is capable of detecting the physical orientation by sensing both gravity and the user's motion. As such, the first wireless loudspeaker device 100 determines that it is in the left ear 702. When multi-channel content 106 is received, presuming that the multi-channel content is stereo audio, the wireless loudspeaker device 100 will deliver the left channel locally to the loudspeaker. Single-channel content 107, i.e. the right channel, will be transmitted by the wireless transceiver 104 to the other wireless loudspeaker device 701 for delivery to its loudspeaker locally.

Turning back to FIG. 1, the wireless loudspeaker device 100 further includes a negotiation module 108. As noted above, one advantage of the present invention is that multiple wireless loudspeaker devices are capable of delivering multi-channel content to a user from a device having a single transceiver. To accomplish this “one device transceiver to multiple wireless loudspeaker device” delivery, one wireless loudspeaker device takes on a dominant role when two wireless loudspeaker devices operate in tandem. In taking on that role, the dominant wireless loudspeaker device maintains a point-to-multipoint connection with both another wireless loudspeaker device and a remote electronic device. A subdominant wireless loudspeaker device, by contrast, maintains only a connection with another wireless loudspeaker device. In so doing, the remote electronic device delivers multi-channel content 106 to a single wireless loudspeaker device, while that dominant wireless loudspeaker device delivers single-channel content 107 to the subdominant wireless loudspeaker device. The negotiation module 108 facilitates the determination of which wireless loudspeaker device will be dominant and which will be subdominant. In other words, the negotiation module 108 is configured to negotiate an ascendancy relationship with a second wireless loudspeaker device.

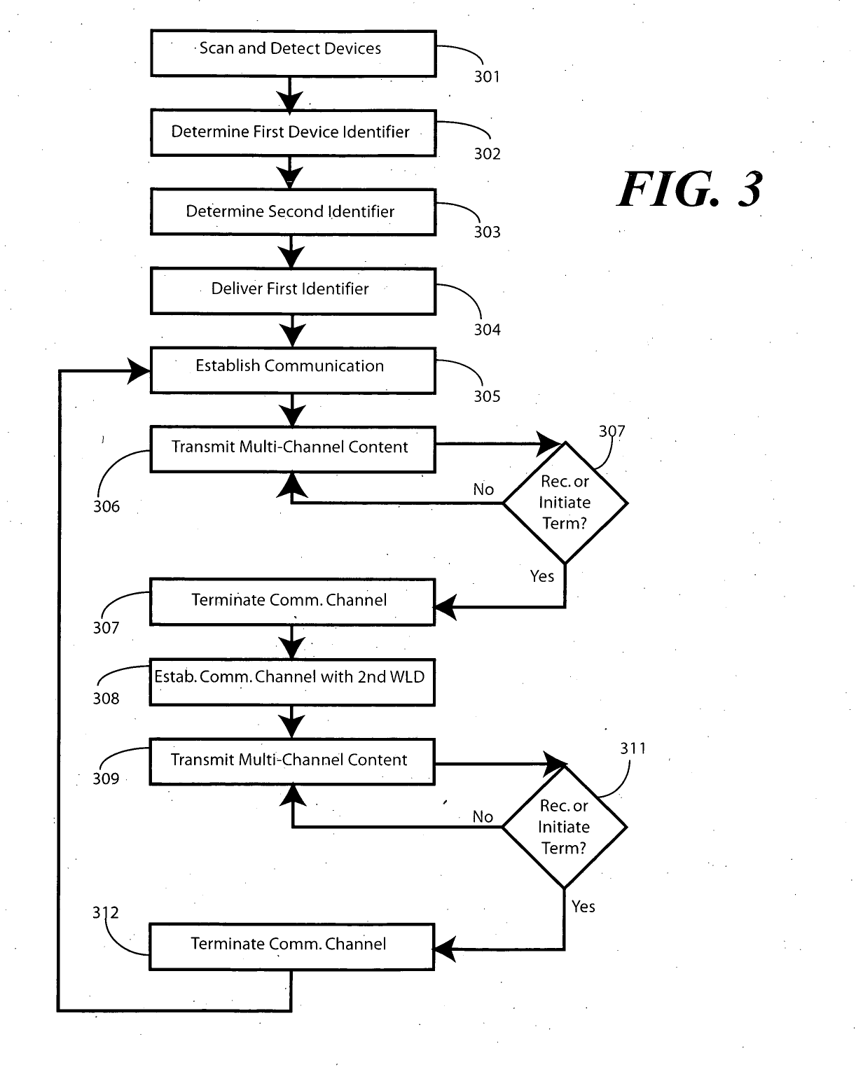

The determination of the ascendancy relationship may be accomplished in a variety of ways. In one embodiment, when a pair of wireless loudspeaker devices are powered on, the first one to be powered up may presume to be dominant. (Note that the configuring process and start-up process will be explained in more detail in the discussion of FIGS. 3-6.) In such an embodiment, the negotiation module 108 in the wireless loudspeaker device 100 first to power on may direct the second wireless loudspeaker device that the first wireless loudspeaker device 100 will serve in the dominant role.

In an alternate embodiment, as the dominant wireless loudspeaker device maintains a point-to-multipoint connection, the dominant wireless loudspeaker device will generally consume more battery power than will the subdominant wireless loudspeaker device. Thus, the negotiation module 108 may determine the relative energy storage levels to determine which wireless loudspeaker device will become the dominant wireless loudspeaker device.

As each wireless loudspeaker device may be configured so as to be worn comfortably within the ear canal, the wireless loudspeaker device 100 includes an electrochemical cell 113 coupled to the processing circuit 101. The electrochemical cell 113, which may be rechargeable and may power the circuitry within the wireless loudspeaker device 100, has a certain amount of usable energy stored therein. A fuel gauge 10 is coupled to both the electrochemical cell 113 and the processing circuit 101. The fuel gauge is capable of determining the amount of energy stored within the electrochemical cell 113 and delivering this information to the processing circuit 101. The processing circuit 101 may then obtain like information from another wireless loudspeaker device by way of the wireless transceiver 104.

A comparator 111 then compares the amount of energy stored within the electrochemical cell 113 with the amount of energy stored within the other wireless loudspeaker device. The negotiation module 108 may then select the wireless loudspeaker device with the most energy to be the dominant wireless loudspeaker device. In other words, when the comparator 111 indicates that the amount of energy stored within the electrochemical cell 113 exceeds the amount of energy associated with the second wireless loudspeaker device, the negotiation module 108 will deliver a dominance identification message to the second wireless loudspeaker device. In one embodiment, hysteresis may be added to the comparator 111 such that the difference between the amount of energy stored within the electrochemical cell 113 and the amount of energy stored in the other wireless loudspeaker device must be greater than a predetermined threshold before the negotiation module 108 delivers a dominance identification message. This hysteresis prevents nuisance toggling when the relative energy levels are close in magnitude.

Turning now to FIG. 2, illustrated therein is a system 200 for delivering multi-channel content to a user in accordance with the invention. The system 200 includes an electronic device 201 having a processor 202 and associated memory 203. Within the memory 203, multi-channel content 204 is stored. The electronic device 201 may be a digital audio or video player, such as a MP3 player. Alternatively, the electronic device 201 may be a personal computer or other portable computing device. In one embodiment, the electronic device 201 is a mobile telephone capable of both making telephone calls and storing and playing multi-channel content 204.

The system 200 also includes a first wireless loudspeaker device 100 and a second wireless loudspeaker device 205. Where the first wireless loudspeaker device 100 serves as the dominant wireless loudspeaker device, the first wireless loudspeaker device 100 is in communication with the electronic device 201, while the second wireless loudspeaker device 205 is in communication with the first wireless loudspeaker device 100. When the first wireless loudspeaker device 100 receives multi-channel content 106 from the electronic device 201, the first wireless loudspeaker device 100 delivers a first channel content to a locally disposed loudspeaker (103), and delivers a second channel content 107 to a the second wireless loudspeaker device 205. In one embodiment, the wireless loudspeaker devices 100,205 include a synchronization module that ensures that the single channel content delivered to the locally disposed loudspeaker (103) and the single channel content 107 delivered to the second wireless loudspeaker device (205) are synchronized temporally. For instance, one of the wireless loudspeaker devices may temporarily buffer received content to allow content to be delivered from both wireless loudspeaker devices 100,205 simultaneously.

A brief discussion of the configuration of the first and second wireless loudspeaker device 100,205 is now in order. When a user first purchases wireless loudspeaker devices 100,205, they generally must be configured or “paired” with the electronic device 201. To accomplish the pairing, especially where the electronic device 201 only has one transceiver 252, each wireless loudspeaker device 100,205 is paired sequentially.

The electronic device 201 first polls the local area for other wireless devices. The electronic device 201 transmits a discovery request 210 to the first wireless loudspeaker device 100 to obtain a unique identifier associated with the first wireless loudspeaker device 100. The electronic device 201 then transmits a second discovery request 211 to the second wireless loudspeaker device 205 to obtain its unique identifier. Once both identifiers are known, the electronic device 201 delivers the unique identifier associated with the first wireless loudspeaker device 100 to the second wireless loudspeaker device 205, thereby alerting the second wireless loudspeaker device 205 of the first wireless loudspeaker device's 100 presence.

Note that the delivery of the unique identifier from the electronic device 201 to the second wireless loudspeaker device 205 is advantageous because the electronic device 201, which is generally a handheld device, often has a richer and more easily readable screen and user interface than does a small device capable of being worn in the ear. However, it will be clear to those of ordinary skill in the art having the benefit of this disclosure that this delivery functionality could be configured within the wireless loudspeaker devices 100,205 themselves. The second wireless loudspeaker device 205 may then initiate a wireless communication channel 212 with the first wireless loudspeaker device 100. A communication channel 221 is thus established between the first wireless loudspeaker device 100 and the second wireless loudspeaker device 205.

Once that the first wireless loudspeaker device 100 is in communication with the second wireless loudspeaker device 205, the negotiation modules 108,208 negotiate an ascendancy relationship between the first wireless loudspeaker device 100 and the second wireless loudspeaker device 205. Presuming for the moment that the first wireless loudspeaker device 100 is to be dominant, the electronic device 201 establishes a communication channel 220 with the first wireless loudspeaker device 100. The electronic device 201 then delivers multi-channel content 106 to the first wireless loudspeaker device 100. The first wireless loudspeaker device 100, maintaining point-to-multipoint communications with both the electronic device 201 and the second wireless loudspeaker device 205, delivers one channel to a locally disposed loudspeaker (103) and the other channel 107 to the second wireless loudspeaker device 205. With this system 200, multi-channel content 106 is successfully delivered to the user.

There are times when the initial ascendancy relationship must be changed. For example, where battery capacity is used to determine ascendancy, the relative battery capacities may change. As such, a handoff module 109,209 operable with each wireless loudspeaker device 100,205 is capable of transferring the dominant role from one wireless loudspeaker device to the other. Using the example set forth in FIG. 2 where wireless loudspeaker device 100 is dominant, suppose for the moment that the negotiation modules 108,208 determine that wireless loudspeaker device 205 should now be dominant. The handoff modules 109,209 must transfer the point-to-multipoint communication from the first wireless loudspeaker device 100 to the second 205.

To accomplish this, handoff modules 109,209 transfer an ascendancy relationship transfer request 231 by wireless communication 230. (Wireless communication 230, which is a control communication path between the wireless loudspeaker devices 100,205, may be used by other modules as well. It is a control communication channel that allows the wireless loudspeaker devices 100,205 to bi-directionally transmit data and messages between the devices.) This can be done by the dominant wireless loudspeaker device (for the moment wireless loudspeaker device 100) transmitting the ascendancy relationship transfer request 231, or by the dominant wireless loudspeaker device 100 receiving an ascendancy relationship transfer request 231 from the subdominant wireless loudspeaker device 205. In either case, the communication channel 220 between the electronic device 201 and the first wireless loudspeaker device 100 is terminated.

The second wireless loudspeaker device 205 then establishes a communication channel 240 with the electronic device 201, and begins receiving multi-channel content 206. The second wireless loudspeaker device 205, now the dominant wireless loudspeaker device, then delivers a first channel locally to a loudspeaker. The other channel 207 is delivered to the first, now subdominant, wireless loudspeaker device 100 along communication channel 241.

In one embodiment of the invention, the wireless loudspeaker devices 100,205 include a user notification device or module 250,251 to alert the user that a handoff or dominance transfer is about to take place. The user notification module 250,251 may be an audible alert, such as a beep or buzz, notifying the user of the pending transfer.

Turning now to FIG. 3, illustrated therein is a method for a device to configure multiple wireless loudspeaker devices for multi-channel streaming in accordance with one embodiment of the invention. The method is similar to the pairing steps discussed above in the discussion of FIG. 2. Such a method may be configured as software commands suitable for execution on a processor in a wireless loudspeaker device in accordance with the invention.

At step 301, the electronic device (201) wirelessly scans a local area piconet to detect device identifiers. Where the wireless communication protocol is Bluetooth, the electronic device (201) may scan the piconet to obtain Bluetooth addresses from other devices within the reception range. Where a pair of wireless loudspeaker devices (100,205) are within a reception range, the electronic device (201) scans the wireless loudspeaker devices (100,205) to determine a unique identifier associated with each device, such as a Bluetooth address for example. The scanning is done to detect these unique identifiers.

At step 302, the electronic device (201) determines a first identifier associated with the first wireless loudspeaker device (100). This identifier may be stored in memory within the electronic device (201). For example, a look-up table containing various device addresses or identifiers nay be stored in memory. At step 303, the process is repeated for the second wireless loudspeaker device (205). Again, the unique device identifier associated with the second wireless loudspeaker device (205) is detected and stored in memory.

At step 304, the electronic device (201) delivers the identifier associated with the first wireless loudspeaker device (100) to the second wireless loudspeaker device (205). By delivering the first device identifier to the second wireless loudspeaker device (205), the electronic device alerts the second wireless loudspeaker device (205) to the first wireless loudspeaker devices presence. Once the first device identifier is known by the second wireless loudspeaker device (205), the second wireless loudspeaker device (205) is able to initiate a communication channel with the first wireless loudspeaker device (100).

At step 305, the electronic device (201) establishes a wireless communication channel with the dominant wireless device. Assuming that the ascendancy relationship is determined by the first to connect, in this example the first wireless loudspeaker device (100) is designated dominant by the negotiation module (108). As such, at step 305, the electronic device (201) establishes a wireless communication channel with the first wireless loudspeaker device (100).

As the second wireless loudspeaker device (205) has initiated a communication channel with the first wireless loudspeaker device (100), and as the electronic device (201) has established a communication channel with the first wireless loudspeaker device (100), the first wireless loudspeaker device (100) now has a point-to-multipoint communication structure established. At step 306, contemporaneously with the second wireless loudspeaker device (205) establishing a communication channel with the first wireless loudspeaker device (100), the electronic device (201) transmits multi-channel content (106) to the first wireless loudspeaker device (100). The first wireless loudspeaker device (100) may then transmit single-channel content (107) to the second wireless loudspeaker device (205).

This communication structure continues until the negotiation modules (108,208) determine that the ascendancy relationship should be changed. At such point, one of the handoff modules (109,209) should notify the electronic device (201) that the communication channel between the electronic device (201) and the first wireless loudspeaker device (100) must be switched to the second wireless loudspeaker device (205). Thus, as seen from the electronic device's perspective, at decision 307 the electronic device (201) checks to see whether one of a communication channel termination request from the first wireless loudspeaker device (100) or a communication channel initiation request from the second wireless loudspeaker device (205) has been received. Where a communication channel termination request is received, such is indicative of the handoff module (109) in the first wireless loudspeaker device (100) initiating the transfer. Likewise, when a communication channel initiation request is received, the handoff module (209) in the second wireless loudspeaker device (205) is initiating the transfer.

When such a request is received, at step 308 the communication channel with the first wireless loudspeaker device (100) is terminated. At step 309, a communication channel is established between the electronic device (201) and the second wireless loudspeaker device (205). Thus, the second wireless loudspeaker device (205) now has the point-to-multipoint connection, while the first wireless loudspeaker device (100) has a connection only with the second wireless loudspeaker device (205). The second wireless loudspeaker device (205) has become dominant. The electronic device thus transmits multi-channel content (206) to the second wireless loudspeaker device (205). The second wireless loudspeaker device (205) may then transmit single-channel content (207) to the first wireless loudspeaker device (100).

This continues until one of a communication channel termination request from the second wireless loudspeaker device (205) or a communication channel initiation request from the first wireless loudspeaker device (100) has been received at decision 311, thereby indicating another handoff. At such time, the communication channel between the electronic device (201) and the second wireless loudspeaker device (205) is terminated at step 312, and a communication channel between the electronic device (201) and the first wireless loudspeaker device (100) is established, thereby transferring dominance back to the first wireless loudspeaker device (100).

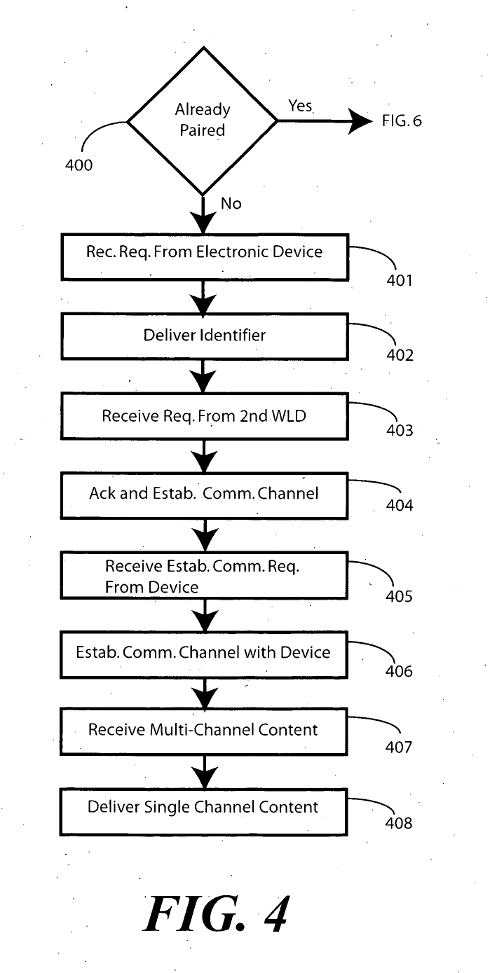

Turning now to FIG. 4, illustrated therein is a method for a wireless loudspeaker device to configure itself for communication with both a remote device and another wireless loudspeaker device in accordance with one embodiment of the invention. In short, the method of FIG. 4 is the method executed by the dominant wireless loudspeaker device in the pairing process. Since it has been described both in the discussion of FIG. 2 and in the discussion of FIG. 3 above, it will be only briefly discussed here.

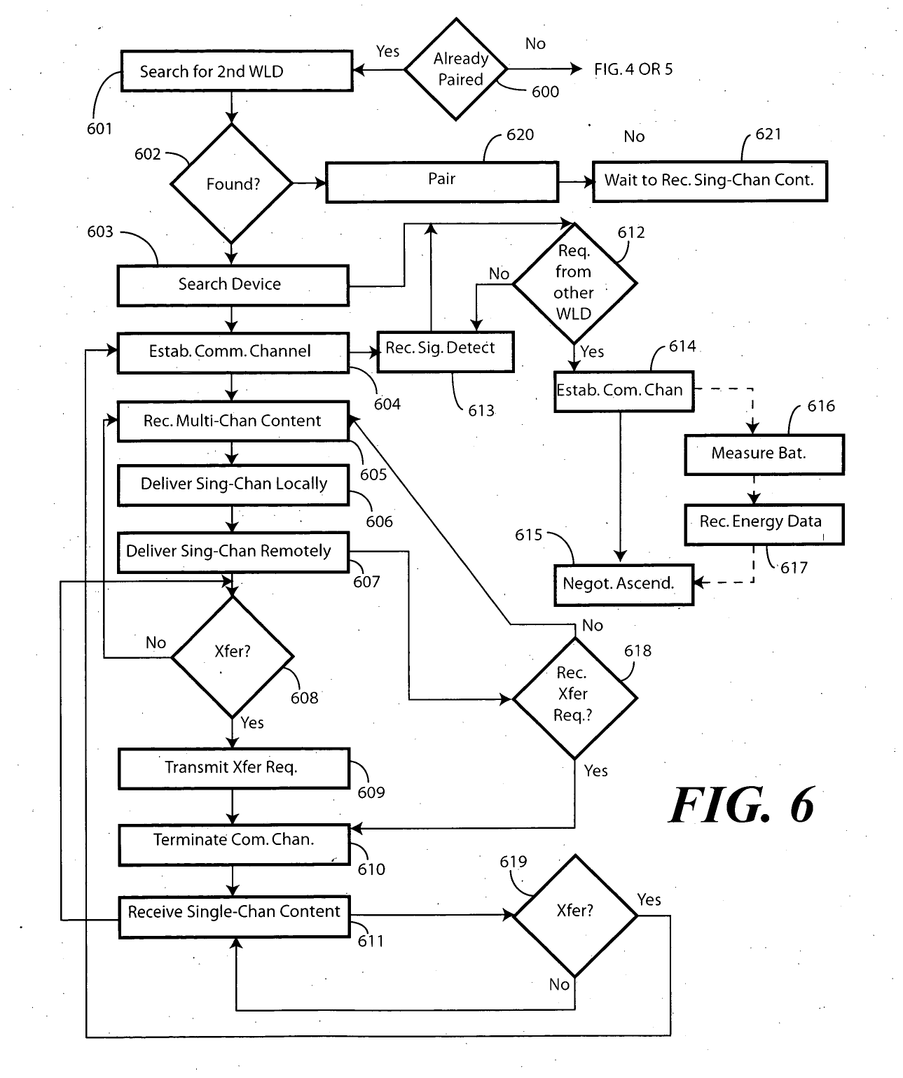

At step 400, upon powerup, the wireless loudspeaker device checks to see if it has been paired in the past. Where it has, the method of FIG. 6 may be executed. Where it has not, at step 401, the first wireless loudspeaker device (100) receives a piconet scanning request from the electronic device (201) for delivery of a unique device identifier associated with the first wireless loudspeaker device (100). At step 402, the first wireless loudspeaker device (100) delivers the device identifier, which may be Bluetooth address in one embodiment, to the electronic device (201).

At step 403, the first wireless loudspeaker device (100) receives a communication channel initiation request from the second wireless loudspeaker device (205). As noted above, this may be accomplished because the electronic device (201) has delivered the device identifier from the first wireless loudspeaker device (1100) to the second wireless loudspeaker device (205).

At step 404, the first wireless loudspeaker device (100) acknowledges the second wireless loudspeaker device (205) and establishes a communication channel with the second wireless loudspeaker device (205). The first leg of the point-to-multipoint communication structure the first wireless loudspeaker device (100) will maintain is complete.

At step 405, the first wireless loudspeaker device (100) receives a communication channel initiation request from the electronic device (201). The first wireless loudspeaker device (100) then establishes a communication channel with the electronic device (201) at step 406. Once the communication channel is established, the electronic device (201) begins delivering multi-channel data. In one embodiment, the multi-channel content comprises stereo, digital music, for example in a MP3 format. This multi-channel content is received by the first wireless loudspeaker device (100) at step 407. At step 408, the first wireless loudspeaker device (100) delivers single-channel content to the second wireless loudspeaker device (205), thereby facilitating the delivery of stereo content to the user.

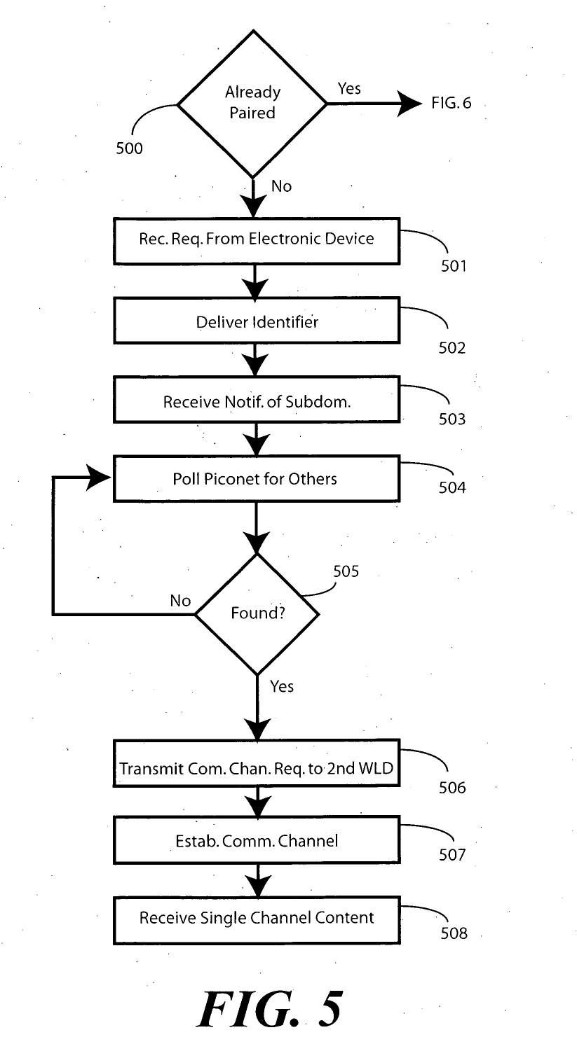

Turning now to FIG. 5, illustrated therein is a method for a wireless loudspeaker device to configure itself for communication with both a remote device and another wireless loudspeaker device in accordance with one embodiment of the invention. Specifically, this is the pairing method as seen from the subdominant wireless loudspeaker device's perspective.

At step 500, upon powerup, the wireless loudspeaker device checks to see if it has been paired in the past. Where it has, the method of FIG. 6 may be executed. Where it has not, at step 501, the second wireless loudspeaker device (205) receives the piconet polling request from the electronic device (201) seeking the unique device identifier associated with the second wireless loudspeaker device (205). At step 502, the second wireless loudspeaker device (205) delivers the device identifier to the electronic device (201). At step 503, the second wireless loudspeaker device (205) receives the device identifier corresponding to the first wireless loudspeaker device (100) from the electronic device (201). Armed with the knowledge of the first wireless loudspeaker device's presence and address, at step 504 the second wireless loudspeaker device (205) polls the piconet for the first wireless loudspeaker device (100) and transmits a communication channel initiation request.

Where the device is found at decision 505, the second wireless loudspeaker device (205) establishes a communication channel with the first wireless loudspeaker device (100). Once this communication channel is established, and once the first wireless loudspeaker device (100) begins receiving multi-channel content from the electronic device, at step 508 the second wireless loudspeaker device (205) receives single-channel content from the first wireless loudspeaker device (100).

As noted above, once the wireless loudspeaker devices (100,205) are paired, they retain the pairing information in non-volatile memory. Turning now to FIG. 6, illustrated therein is the boot method each wireless loudspeaker device (100,205) executes on power-up. Note that while in one embodiment each wireless loudspeaker device (100,205) executes the same method, the sequential steps each executes will be slightly different due to the temporal relationship in the respective times of actuation for the devices.

At step 600, upon powerup, the wireless loudspeaker device checks to see if it has been paired in the past. Where it has not, the methods of FIG. 4 or 5 may be executed. Where it has, at step 601, in one embodiment, upon power up, a wireless loudspeaker device (100) in accordance with the invention will poll the local piconet in search of a like wireless loudspeaker device. For example, where the wireless loudspeaker device (100) has been configured in accordance with the steps set forth in FIG. 4, upon power up the wireless loudspeaker device (100) will search locally for its pre-paired companion wireless loudspeaker device (205). Assuming for the moment that wireless loudspeaker device (100) is the first to power up, it will not find wireless loudspeaker device (205) at decision 602. Upon not finding the companion wireless loudspeaker device (205), wireless loudspeaker device (100) will then search for an electronic device (201) at step 603. The search will continue until either the electronic device (201) is found, or the wireless loudspeaker device (100) is powered down.

Once the electronic device (201) is found, the wireless loudspeaker device (100) will establish a wireless communication channel with the remote electronic device (201) at step 604. In one embodiment, where the wireless communication protocol is Bluetooth, the step of establishing a wireless communication channel with the remote electronic device 604 may include either establishing a class 1 Bluetooth communication channel or establishing a class 2 Bluetooth communication channel. Once companion wireless loudspeaker device (205) is powered up, as it executes the same method, its first step is to search for its pre-paired twin, i.e. wireless loudspeaker device (100). Since its companion wireless loudspeaker device (100) is powered up, rather than searching for the electronic device at step 603, the second wireless loudspeaker device (205) will pair with the first wireless loudspeaker device (100) at step 620. Thus, at some time in parallel, wireless loudspeaker device (100) will receive a communication channel initiation request from the matching wireless loudspeaker device (205), as indicated by decision 612. When this communication channel initiation request is received, wireless loudspeaker device (100) establishes a second wireless communication channel with the matching wireless loudspeaker device (205) at step 614. In one embodiment, where the wireless communication protocol is Bluetooth, this step 614 may include establishing a class 3 Bluetooth communication channel.

As discussed above, the negotiation modules (108,208) of each device negotiate an ascendancy relationship between wireless loudspeaker device (100) and wireless loudspeaker device (205) at step 615. Where the ascendancy relationship is determined by relative energy storage levels, prior to negotiating the ascendancy relationship between the wireless loudspeaker devices (100,205) the negotiation process may optionally include the steps of determining an amount of energy stored in a locally disposed power source 616 and receiving energy storage information from the matching wireless loudspeaker device (205) at step 617. Where the amount of energy stored is greater than the amount of energy read from the energy storage information, as a part of negotiating the ascendancy relationship 615 wireless loudspeaker device (100) may transmit a dominance identification message to the matching wireless loudspeaker device 205). Where the “first to power up” is the modus of determining the ascendancy relationship, step 615 may include the transmission of a dominance identification message to the matching wireless loudspeaker device (205) without optional steps 616,617. Once subdominant, the subdominant wireless loudspeaker device waits for single-channel content at step 621.

Next the electronic device (201) begins transmitting multi-channel content, which is received by wireless loudspeaker device (100) at step 605. As wireless loudspeaker device (100) has a point-to-multipoint communication structure in place, wireless loudspeaker device (100) may deliver a first channel of content to a locally disposed loudspeaker at step 606, and may transmit a second channel of content to the matching wireless loudspeaker device (205) at step 607.

As noted above, there will be situations where the ascendancy relationship needs to be renegotiated. This may be done, in one embodiment, by either wireless loudspeaker device (100,205). Either the dominant wireless loudspeaker device (100) may transmit an ascendancy relationship transfer request to the matching wireless loudspeaker device (205), or the dominant wireless loudspeaker device (100) may receive an ascendancy relationship transfer request from the subdominant wireless loudspeaker device (205). The former process begins at decision 608, while the latter process begins at decision 618.

At decision 608, the negotiation module (108) in the dominant wireless loudspeaker device (100) determines whether a transfer is warranted. Where it is, the dominant wireless loudspeaker device (100) will transfer an ascendancy relationship transfer request to the subdominant wireless loudspeaker device (205) at step 609. At step 610, the wireless communication channel between wireless loudspeaker device (100) and the electronic device (201) is terminated. A new communication channel (240) is then established between the second wireless loudspeaker device (205) and the electronic device (201), thereby making the second wireless loudspeaker device (205) dominant. As the second wireless loudspeaker device (205) will now become dominant, single-channel content is received from wireless loudspeaker device (205) at step 611. Receipt of the single-channel content is verified at decision 619.

The receipt of an ascendancy relationship transfer request is determined at decision 618. Where this is the case, again, the wireless communication channel between wireless loudspeaker device (100) and the electronic device (201) is terminated. As the second wireless loudspeaker device (205) will now become dominant, single-channel content is received from wireless loudspeaker device (205) at step 611.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method for configuring a pair of wireless loudspeaker devices to receive multi-channel content from a remote electronic device, the method comprising the steps of:
a. scanning the pair of wireless loudspeaker devices, each wireless loudspeaker device having a unique device identifier associated therewith, to detect the unique device identifiers;
b. determining a first device identifier associated with a first wireless loudspeaker device;
c. determining a second device identifier associated with a second wireless loudspeaker device;
d. delivering the first device identifier to the second wireless loudspeaker device;
e. establishing a wireless communication channel with the first wireless loudspeaker device; and
f. contemporaneously with the second wireless loudspeaker device establishing a communication channel with the first wireless loudspeaker device, transmitting multi-channel content to the first wireless loudspeaker device.

2. The method of claim 1, further comprising the steps of:
a. receiving one of a communication channel termination request from of the first wireless loudspeaker device and a communication channel initiation request from the second wireless loudspeaker device;
b. terminating the wireless communication channel with the first wireless loudspeaker device;
c. establishing a wireless communication channel with the second wireless loudspeaker device; and
d. transmitting multi-channel content to the second wireless loudspeaker device.

3. A method for configuring a plurality of wireless loudspeaker devices to receive multi-channel content from a remote electronic device, the method comprising the steps of:
a. delivering a device identifier to the electronic device;
b. receiving a communication channel initiation request from a wireless loudspeaker device;
c. establishing a communication channel with the wireless loudspeaker device;
d. receiving a communication channel initiation request from the electronic device;
e. establishing a communication channel with the electronic device;
f. receiving multi-channel content from the electronic device; and
g. delivering single-channel content to the wireless loudspeaker device.

4. A method for configuring a pair of wireless loudspeaker devices to receive multi-channel content from an electronic device, the method comprising the steps of:
a. delivering a device identifier to the electronic device;
b. receiving a device identifier corresponding to a wireless loudspeaker device from the electronic device;
c. transmitting a communication channel initiation request to the wireless loudspeaker device;
d. establishing a communication channel with the wireless loudspeaker device;
e. upon the wireless loudspeaker device receiving multi-channel content from the electronic device, receiving single-channel content from the wireless loudspeaker device.

5. A method for establishing a multi-channel content communication channel with remote devices, the method comprising the steps of:
a. polling a piconet in search of a remote electronic device;
b. establishing a wireless communication channel with the remote electronic device;
c. receiving a communication channel initiation request from a matching wireless loudspeaker device;
d. establishing a second wireless communication channel with the matching wireless loudspeaker device; and
e. negotiating an ascendancy relationship with the matching wireless loudspeaker device.

6. The method of claim 5, further comprising the steps of:
a. receiving multi-channel content form the remote electronic device;
b. delivering a first channel content to a locally disposed loudspeaker; and
c. transmitting a second channel content to the matching wireless loudspeaker device.

7. The method of claim 5, wherein the step of negotiating the ascendancy relationship comprises transmitting a dominance identification message to the matching wireless loudspeaker device.

8. The method of claim 6, further comprising the steps of:
a. one of receiving an ascendancy relationship transfer request from the matching wireless loudspeaker device and transmitting an ascendancy relationship transfer request to the matching wireless loudspeaker device;
b. terminating the wireless communication channel with the remote electronic device; and
c. receiving single-channel content from the matching wireless loudspeaker device.

9. The method of claim 5, further comprising the steps of:
a. prior to negotiating the ascendancy relationship with the matching wireless loudspeaker device, determining an amount of energy stored in a locally disposed power source;
b. receiving energy storage information from the matching wireless loudspeaker device; and
c. where the amount of energy stored is greater than an amount of energy read from the energy storage information, transmitting a dominance identification message to the matching wireless loudspeaker device.

10. The method of claim 5, wherein the step of establishing a wireless communication channel with the remote electronic device comprises one of establishing a class 1 Bluetooth communication channel and establishing a class 2 Bluetooth communication channel, further wherein the step of establishing a second communication channel comprises establishing a class 3 Bluetooth communication channel.

11. A wireless loudspeaker device, comprising:
a. a processing circuit and associated memory;
b. a wireless transceiver coupled to the processing circuit;
c. a loudspeaker coupled to the processing circuit;
d. a communication module operable with the processing circuit configured to establish a wireless communication channel with one of a remote electronic device and a second loudspeaker device; and
e. a distribution module operable with the processing circuit configured to receive multi-channel content from the remote electronic device and to deliver single-channel content to the second wireless loudspeaker device.

12. The wireless loudspeaker device of claim 1 further comprising an orientation module operable with the processing circuit, wherein the orientation module determines a physical orientation of the wireless loudspeaker device, thereby causing the distribution module to deliver channel content associated with the physical orientation to the wireless loudspeaker device.

13. The wireless loudspeaker device of claim 11, further comprising a negotiation module operable with the processing circuit, the negotiation module configured to negotiate an ascendancy relationship with a second wireless loudspeaker device.

14. The wireless loudspeaker device of claim 13, further comprising:
a. an electrochemical cell coupled to the processing circuit;
b. a fuel gauge coupled to the processing circuit, the fuel gauge being configured to determine an amount of energy stored within the electrochemical cell; and
c. a comparator configured to compare the amount of energy stored within the electrochemical cell with an amount of energy associated with the second wireless loudspeaker device.

15. The wireless loudspeaker device of claim 14, wherein when comparator indicates the amount of energy stored within the electrochemical cell exceeds the amount of energy associated with the second wireless loudspeaker device, the negotiation module transmits a dominance identification message to the second wireless loudspeaker device.

16. The wireless loudspeaker device of claim 11, wherein the wireless loudspeaker device is configured so as to be wearable in a human ear.

17. The wireless loudspeaker device of claim 11, wherein the wireless transceiver comprises a Bluetooth compatible communication device.

18. A system for delivering multi-channel content to a user, the system comprising:
a. an electronic device having multi-channel content stored therein;
b. a first wireless loudspeaker device, the first wireless loudspeaker device being in communication with the electronic device;
c. a second wireless loudspeaker device, the second wireless loudspeaker device being in communication with the first wireless loudspeaker device;
wherein upon receiving the multi-channel content from the electronic device, the first wireless loudspeaker device delivers a first channel content to a locally disposed loudspeaker, and delivers a second channel content to a the second wireless loudspeaker device.

19. The system of claim 18, wherein the electronic device comprises a mobile telephone, further wherein the first wireless loudspeaker device and the second wireless loudspeaker device comprise identical Bluetooth compatible earpieces capable of being worn in a user's ear.

20. The system of claim 18, wherein the first wireless loudspeaker device and the second wireless loudspeaker device each comprise an ascendancy negotiation module, wherein ascendancy is determined by one of a connection order with the electronic device and a relative energy storage level.

21. The system of claim 20, wherein the first wireless loudspeaker device and the second wireless loudspeaker device each comprise a handoff module configured to transfer delivery of the multi-channel content by terminating delivery of the multi-channel content to the first wireless loudspeaker device upon receiving an ascendancy relationship transfer request, wherein upon termination of delivery, the electronic device initiates delivery of multi-channel content to the second wireless loudspeaker device.

22. The system of claim 21, wherein one of the first wireless loudspeaker device and the second wireless loudspeaker device comprises a user notification module configured to notify a user when the handoff module transfers delivery of the multi-channel content.
